(19) United States
(12) Patent Application Publication
(10) Pub. No.: US 2024/0256842 A1
(43) Pub. Date: Aug. 1, 2024

(54) Ultra Low Bit Quantization And Neural Networks

(71) Applicant: Deeplite Inc., Montreal (CA)

(72) Inventors: Muhammad Saad ASHFAQ, Toronto (CA); MohammadHossein ASKARI HEMMAT, Montreal (CA); Sudhakar SAH, Markham (CA); Ehsan SABOORI, Richmond Hill (CA); Ahmed HASSANIEN, Montreal (CA); Olivier MASTROPIETRO, Montreal (CA); Alexander HOFFMAN, Montreal (CA)

(73) Assignee: Deeplite Inc., Montreal (CA)

(21) Appl. No.: 18/159,889

(22) Filed: Jan. 26, 2023

(51) Int. Cl. G06N 3/0495; G06N 3/082; G06N 3/10

(52) U.S. Cl. CPC G06N 3/0495; G06N 3/082; G06N 3/10

(57) ABSTRACT

A system, method, and computer readable medium for deploying neural networks in low bit environments. The system comprises a runtime platform, a first set of configuration parameters identifying limitations of the runtime platform, and a quantization platform for quantizing neural networks. The quantization platform receives a neural network associated with a framework and quantizing the neural network into a smaller neural network and generates a dataset comprising a second set of configuration parameters for compiling the smaller neural network into instructions for the runtime platform. The second set of configuration parameters are responsive to the limitations of the first set of configuration parameters. The runtime environment implements the smaller neural network in accordance with the second set of configuration parameters.

### TECHNICAL FIELD

The following generally relates generally to approaches to quantize and implement neural networks.

### BACKGROUND

Modern machine learning models (e.g., for computer vision) are achieving accuracies and detection performance with potential for new product developments across multiple domains (e.g., home surveillance cameras, AI traffic monitoring systems, automotive driver assistance, mobile video applications and intelligent consumer electronics, etc.).

The aforementioned machine learning models are typically deployed on existing server infrastructure (e.g., cloud-based infrastructure), and can rely on high-performance data center graphics processing units (GPUs) and central processing units (CPUs). However, certain applications may require better latency, reliability, connectivity, privacy, and/or cost effectiveness, which cloud-based infrastructure may not be able to provide. As examples, in the machine vision space alone, these considerations are impacting uploading non-anonymized facial data for surveillance (e.g., potential privacy concerns), real-time person detection in vehicles requiring on device processing, and always-on person ID with smart doorbell cameras (e.g., require more cost-effective inference performance). Therefore, it is desirable for machine learning models to be enabled within devices which provide the inputs to the models (referred to interchangeably as “edge” devices).

Edge devices, however, are found to be lacking in several respects. For example, edge devices typically lack sufficient processing power to run the large machine learning models. Edge devices are also typically expensive to retrofit (if that is at all possible) to run the previously mentioned models, whether in real-time, in all-the-time conditions, or otherwise. Moreover, edge devices may deteriorate if configured to run these models (e.g., overheating can be an issue). These factors, and others, have been a major barrier to adopting sophisticated models on edge devices.

Model quantization is one way to improve the performance of machine learning models to overcome edge limitations. Current quantization frameworks and inference engines predominantly use 8-bit integer (INT8) quantization for model weights and activations, instead of using the same precision as training, typically 32-bit floating-point (FP32). Existing methods for neural network quantization can be classified into two categories [24], Post-training Quantization (PTQ) and Quantization-Aware Training (QAT). PTQ does not require the original network to be re-trained on the target dataset and is therefore typically limited to FP16 or INT8 quantization, where sufficient information is preserved in the original training statistics to accurately quantize the network. On the other hand, QAT quantizes the network during training and preserves significantly more accuracy than PTQ. QAT methods have been tested at as low as INT4 precision [23] using 4 bits per neural network weight and 8 bits per activation. However, INT4 quantization in [23] is tested only on classification models. Low bit quantization is much more difficult in implement for object detection problems, at least because of challenges to maintain accuracy. Significant work to quantize the model using just 1 bit is also available but such models suffer from accuracy loss beyond 10% [26],[27].

While known quantization potentially provides a speedup, it often cannot overcome the existing limitations. For example, quantization can reduce the model accuracy below acceptable threshold(s).

Another approach to overcome edge device limitations includes low complexity light weight models like MobileNet [2]. These models, however, are handcrafted and are found to lack the performance needed for many applications (e.g., computer vision applications). Also, because of their handcrafted and compact architecture, compression techniques such as quantization are generally not effective [18] and custom modifications might be necessary to accommodate quantization [22].

Even when high accuracy quantized models with 1-2 bits of precision are available, they are not deployed on commercial off-the-shelf hardware [19] due to lack of support for 1 or 2-bit instructions and operators. For example, most available hardware (also referred to as commodity hardware) only supports down to 8-bit operations. Similarly, existing machine learning frameworks such as TensorFlow [15] and PyTorch [16] do not support 1 bit or 2 bits of precision. Open-source runtimes and compilers such as TFLite [10] and TVM [28] currently support 8 bits of precision with quantization. Such devices either need a custom inference engine for the runtime or custom hardware support like INT4 instructions provided in advanced NVIDIA processors [25].

Running models with sub-8-bit precision on commodity hardware has been explored before, however previous proposals have been rigid, enforcing circumstance-specific configurations or limitations. For example, TernGEMM [32] proposes a GEMM based method that uses logical bitwise operators to perform matrix multiplication for only ternary weights, {−1, 0, 1}, and 3 to 6-bit activations. Han et al. [13], developed low precision convolution kernels and optimization passes in the TVM machine learning compiler to compute sub-8-bit operations on commodity hardware. ULLPACK [33] presents two packing schemes for low precision operations that allow for a trade-off between accuracy and speed. These attempts, however, have been found to not provide satisfactory performance at least as a result of supporting only unipolar encoding for both weights and activations.

For at least the above reasons, effective low bit quantization and implementation remains a challenge from a variety of perspectives (e.g., from a QAT perspective, from an effective runtime perspective, etc.).

### SUMMARY

Deep learning models have been found in prior attempts, to be robust to quantization. However, how many bits is enough for certain AI tasks remains an open-ended question ever since early work on post-training and training-aware quantization, such as in [5] and [6].

The high latency and low throughput for current machine learning models on commodity CPUs like the Cortex-A72 in the Raspberry Pi 4B demonstrates the harsh limitations of AI inference on low power and affordable processors. Despite there being billions of devices powered by ARM Cortex-A CPUs, even the latest quantization techniques did not provide sufficiently low latency numbers for practical applications. Although reducing the model parameters from 32 bits to 8 bits results in respectable speedup without a significant loss in accuracy, it may still not be enough to run these models on such small footprint hardware. Furthermore, many of the compact networks [2] designed for these devices were not accurate enough, including the smaller variations of YOLOv5n [1].

To potentially address the above-noted defects, the following proposes one or more of (1) QAT with 1 and 2-bit precision (weights and activations) for object detection and classification models, (2) a mixed precision approach to minimize the accuracy drop of quantized models, (3) a custom ultra-low precision convolution operator(s) to accelerate speed and memory throughput of quantized layers, and (4) an end-to-end framework to deploy and execute mixed precision ultra-low bit quantized models on commonly available processors (e.g., Armv7 and Armv8 Cortex-A processors).

The disclosed runtime includes an ultra-low precision inference engine, and a quantization framework to coordinate with the runtime to implement machine learning models according to a dataset with configuration parameters. The configuration parameters facilitate low bit implementations, by specifying a quantization approach to arrive at a target precision, and/or by mapping existing machine learning framework kernels (operators) to kernels more responsive to low-bit environments. The runtime and framework can cast relevant parameters to take advantage of the low-bit environment specialized kernels, thereby facilitating implementing models of known machine learning frameworks to ultra-low bit environments. A system can be configured to automatically quantize and optimize convolutional neural network (CNN) models with less than four (4) bits of precision. As a result, the disclosed runtime platform may empower developers to unlock advanced AI on widely available low-power Arm-based devices.

Experimental results indicate that the proposed approaches can achieve up to five times faster inference compared to optimized FP32 baselines and up to two times faster inference for classification models relative to TFLite [10] used with the highly optimized XNNPACK [12] backend. Experimental testing indicates speedups on object detection models via the disclosed quantization and implementation that may be up to 3.2× and 2.2× compared to ONNX Runtime and TFLite with XNNPACK, respectively.

In an aspect, this disclosure proposes using advances in a CNN based model optimization software, and a quantization-aware training method to quantize both model weights and activations below 4 bits. In addition, a method of saving and inferring such models on low-power CPUs are also disclosed.

Experimental comparisons to full-precision and INT8 baselines indicate that the approach can be effective, based on benchmark comparisons to state-of-the-art object detection models on a Raspberry Pi 4B platform.

In one aspect, there is provided a system for deploying neural networks in low bit environments. The system comprises a runtime platform, a first set of configuration parameters identifying limitations of the runtime platform, and a quantization platform for quantizing neural networks. The quantization platform receives a neural network associated with a framework and quantizing the neural network into a smaller neural network and generates a dataset comprising a second set of configuration parameters for compiling the smaller neural network into instructions for the runtime platform. The second set of configuration parameters are responsive to the limitations of the first set of configuration parameters. The runtime environment implements the smaller neural network in accordance with the second set of configuration parameters.

In example embodiments, the runtime platform includes two or more operators, and the second set of configuration parameters specify at least one of (1) an order of the two or more operators, or (2) a composition of the two or more operators for use by the runtime environment.

In example embodiments, the first set of configuration parameters relate to at least one of a target precision, a resulting layout of the smaller neural network, a target accuracy, and a target architecture.

In example embodiments, the target architecture indicates the two or more operators.

In example embodiments, at least some of the second set of configuration parameters are for a subset of the plurality of nodes.

In example embodiments, the first set of configuration parameters or the second set of configuration parameters includes different configuration parameters for different nodes of the plurality of nodes.

In example embodiments, quantizing the network comprises training the neural network to satisfy at least one of the configuration parameters. In example embodiments, the training is performed with a first device, and the smaller neural network is output to a second device.

In example embodiments, the quantization platform reuses the first set of configuration parameters for quantizing another neural network.

In another aspect, a method for deploying neural networks in low bit environments is disclosed. The method includes providing a quantized neural network having a plurality of operations. The method includes providing a set of configuration parameters for implementing the quantized neural network with a runtime platform having two or more operators. The method includes compiling the quantized neural network to generate compiled code, the compiled code specifying implementing at least some of the plurality of operations of the generated compiled code with one of the two or more operators, based on the set of configuration parameters. The method includes implementing the generated compiled code with the runtime platform.

In example embodiments, the set of configuration parameters specifies implementing different operators of the two or more operators for various parts of the compiled code.

In example embodiments, the two or more operators include one or more custom operators.

In example embodiments, the set of configuration parameters specifies different operators of the two or more operators for different layers of the quantized neural network.

In example embodiments, the method includes providing a neural network from a framework associated with a second runtime platform having one or more operators. The example method includes quantizing the neural network into the quantized neural network. The set of configuration parameters for implementing the quantized neural network specifies implementing at least some of the plurality of operations of the generated compiled code with the one or more operators of the first runtime environment and further specifies implementing at least some of the plurality of operations of the generated compiled code with the two or more operators.

In example embodiments, the method includes updating the two or more operators.

In example embodiments, compiling the quantized neural network includes casting elements of the quantized neural network from a first data type into a second data type.

In example embodiments, the runtime platform can process compiled code from different code compilers or operate on more than one device type.

In example embodiments, the set of configuration parameters specify a target encoding scheme for at least some weights and activations of the quantized neural network. In example embodiments, the encoding scheme is unipolar or bipolar.

In another aspect, a computer readable medium storing computer executable instructions is disclosed. The instructions cause a processor to provide a quantized neural network having a plurality of operations. The processor provides a set of configuration parameters for implementing the quantized neural network with a runtime environment having two or more operators. The processor compiles the quantized neural network to generate compiled code, the compiled code specifying implementing at least some of the plurality of operations of the generated compiled code with one of the two or more operators, based on the set of configuration parameters. The processor implements the generated compiled code with the runtime environment.

In another aspect, a method for performing operations is disclosed. The method includes providing a neural network, the network comprising a plurality of neurons associated with a respective plurality of weights and plurality of activation values. The method includes splitting the plurality of weights and the plurality of activation values into separate bitplanes. The method includes consolidating separate bitplane combinations of the plurality of weights and the plurality of activation values.

In example embodiments, one of the plurality of weights and the plurality of activation values are encoded with bipolar encoding. In example embodiments, the plurality of weights are encoded with bipolar encoding.

In example embodiments, one of the plurality of weights and the plurality of activation values are encoded with unipolar encoding.

In example embodiments, the plurality of activation values are encoded with unipolar encoding.

In example embodiments, consolidating is based on the bitserial dot product between the plurality of weights and the plurality of activation values.

### BRIEF DESCRIPTION OF THE DRAWINGS

Embodiments will now be described with reference to the appended drawings wherein:

FIG. 1A shows an existing system for implementing machine learning models.

FIG. 1B shows an example neuron of an example machine learning model.

FIGS. 2A, 2B, and 2C each show a system for implementing machine learning models, according to the disclosure herein.

FIG. 3 shows a computing environment for implementing machine learning models.

FIG. 4 is a block diagram of a method for deploying quantized neural networks.

FIG. 5 is a block diagram of another method for deploying quantized neural networks.

FIG. 6 is a block diagram of a method for performing convolutions.

FIGS. 7 and 8 show graphs of the results of benchmark testing of existing approaches to implementing machine learning models.

FIGS. 9A and 9B show a graph of the results of benchmark testing of known runtimes for implementing machine learning models.

FIGS. 10, 11, 12 and 13 show graphs of the results of experimental testing of an example runtime for implementing machine learning models.

### DETAILED DESCRIPTION

As used herein, it is understood that the term “quantize”, and related terms, refer(s) to a process which results in the reduction of a neural network. The terms are not intended to be limiting in respect of how, or to the extent, they indicate reduction in the size of the neural network. For example, the term reduction can include reducing the precision of one or more weights of the neural network (i.e., reducing the amount of memory required to implement the neural network), or removing neurons from the neural network, etc.

It is also understood that the terms neural network, machine learning model, and artificial intelligence model, and related terms, are used interchangeably within the present disclosure (unless explicitly recited otherwise). The aforementioned terms do not limit the scope of this disclosure in any way, and refer generally to computer implemented models which rely upon structures that require the operation of computer implemented neurons (referred to simply as neurons hereinafter), which neurons can include weights, an activation function, a summary function(s), etc.

It is understood that the term “file,” and related terms, refer(s) to stored data in different forms, and is not intended to be limited to a particular configuration (e.g., a distinct file), or a particular format, or a particular location, etc. For clarity, the term configuration file does not require the existence of a separate file, and the configuration parameters discussed in relation to the configuration file can be stored alongside another dataset, application, or computer software instance. 207

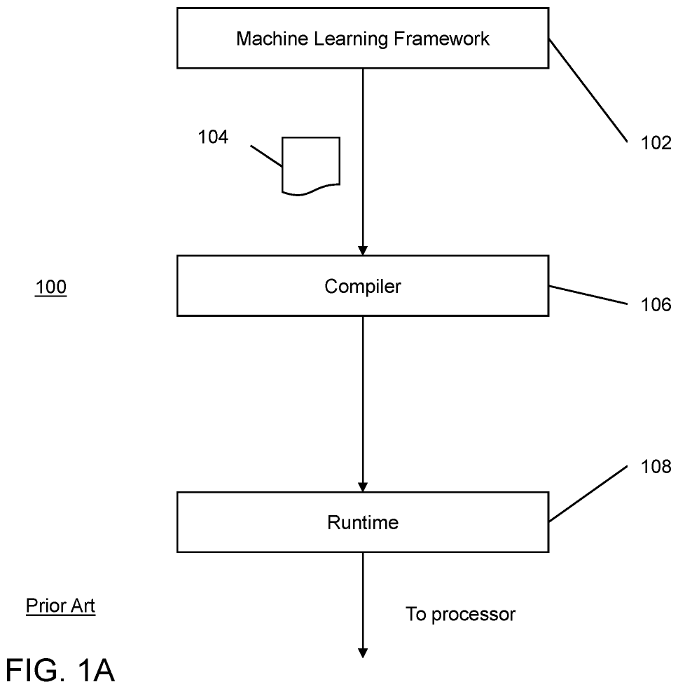

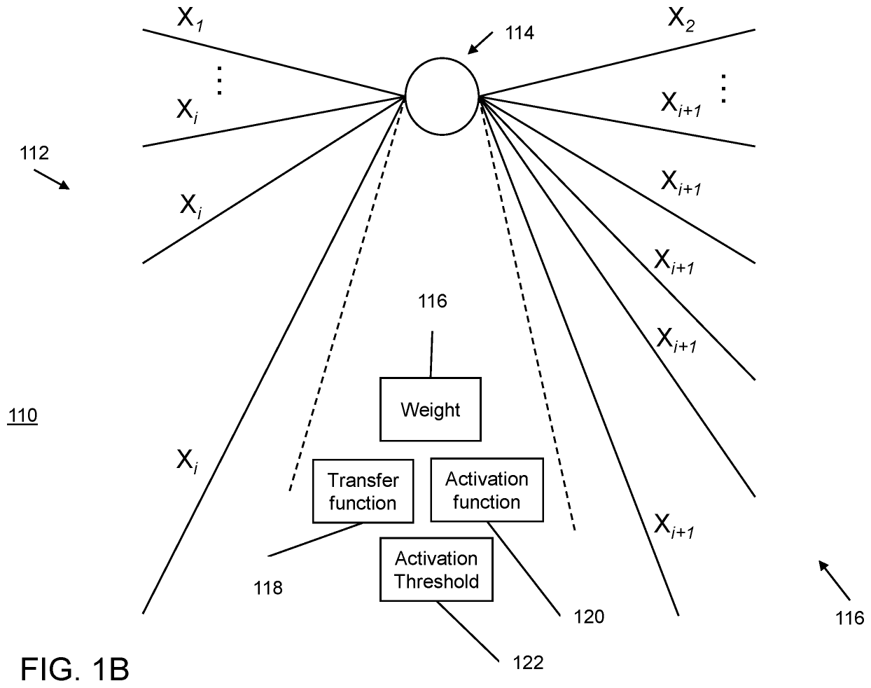

Referring now to FIG. 1A, an example system 100 for implementing neural networks (including more than one neuron 110 as shown in FIG. 1B) as is known in the prior art is shown. In known systems, implementing a neural network within a computing environment, includes a machine learning framework 102, a compiler 106, and a runtime 108.

The machine learning framework 102 enables a device user (e.g., programmer) to write or otherwise generate computer code which realizes the machine learning model or code 104, specifies training parameters used to generate the model 104, etc. Examples of existing machine learning frameworks 102 include the TensorFlow and PyTorch frameworks. Existing frameworks 102 do not support runtime environments having lower than 8-bit operations.

The machine model 104 includes two or more neurons 110, an example of which is shown in FIG. 1B. This disclosure is not limited to the configuration shown in FIG. 1B, and it is understood that the example is merely illustrative (e.g., the neuron 110 can be a simple neuron, a long short term memory type neuron, etc.). Neuron 110 receives one or more inputs 112, performs one or more processes to the received input based on one or more parameters 114, and thereafter outputs one or more outputs 116. Depending on the configuration of the network 104, the neuron 110 can be connected to a plurality of other neurons within the model 104. For example, in the shown embodiment, the neuron 110 is connected to four (4) preceding neurons and generates outputs which are transmitted to six (6) neurons downstream of the neuron 110.

The one or more parameters 114 of the neuron 110 can include a weight 116, a transfer function 118, an activation function 120, and an activation threshold 122. The transfer function 118 can be applied to the weight 116 and the received input, and the activation function 120 can be used to determine whether the output of the transfer function 118 satisfies the activation threshold 122. If the activation threshold 122 is satisfied, the neuron 110 can provide an output 116.

Referring again to FIG. 1A, the compiler 106 receives the machine learning code 104 from the machine learning framework 102 and converts the human understandable computer code into a machine interpretable compiled code (e.g., binary code). The runtime environment 108 receives the compiled code from the compiler 106, and using one or more operators, implements the compiled code on hardware (not shown, such as the Arm processors discussed herein).

In FIG. 1A, it is assumed that the machine learning framework 102, compiler 106, and runtime 108 can implement the created machine learning model 104 within the environment 100. This is an idealized model, and in the real world, many devices are incapable of implementing large and sophisticated machine learning models.

This disclosure relates to related methods, systems, and computer readable mediums for quantizing neural networks for low bit environments. The term “ultra low bit” is used to denote four (4) or less bit processes, in contrast to the 8-bit processes supported by most commodity hardware in existing systems.

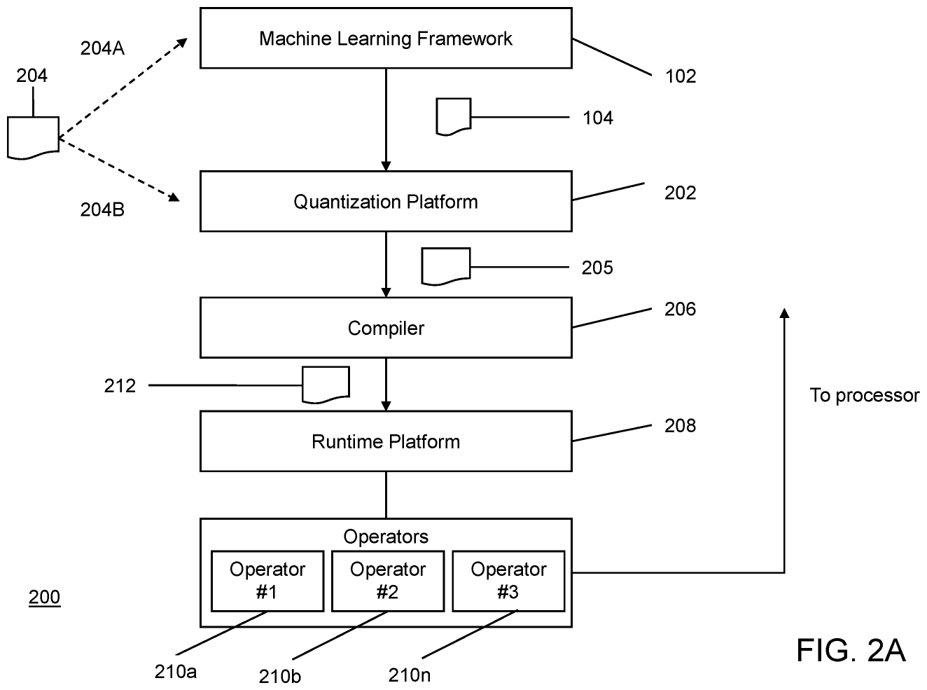

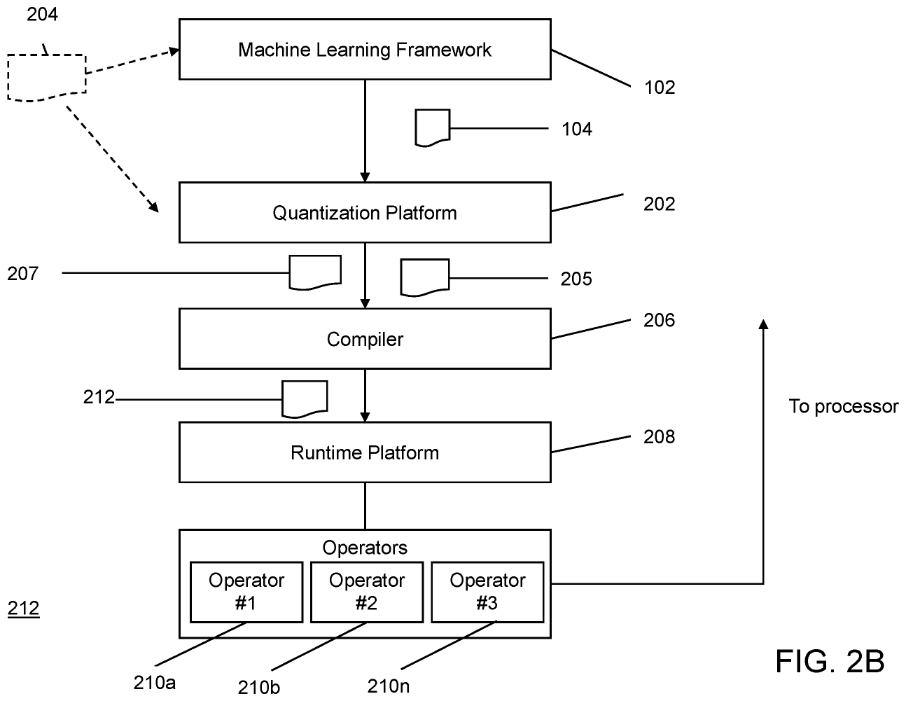

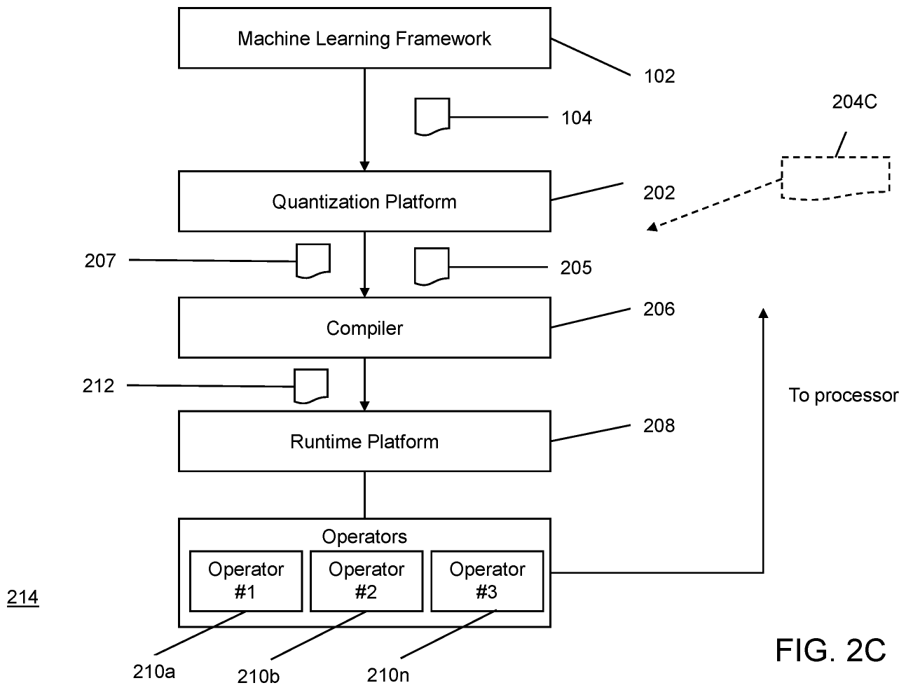

Referring now to FIGS. 2A, 2B, and 2C, example systems 200, 212, and 214 for quantizing a neural network for low-bit environments are shown. The example systems can, for example, be implemented on Armv7 or Armv8 architectures, on the Raspberry Pi 4B, etc.

Systems 200, 212, and 214 include the machine learning framework 102, and a quantization platform 202, a compiler 206, and a runtime platform 208. Together, the quantization platform 202, the compiler 206, and the runtime platform 208 can enable the use of existing machine learning frameworks 102 (which are not capable of operating in low bit environments) for low bit environments. The machine learning framework 102 can also be a custom framework.

As in FIG. 1A, the machine learning framework 102 is used to generate a machine learning model 104. It is understood that the machine learning model 104 can take a variety of forms, including datasets which store the model weights and other parameters in the FP32 format, the INT8 format, etc.

The quantization platform 202 receives the model 104 generated by the machine learning framework 102. The machine learning model 104 can be a trained model, and the quantization platform 202 can perform PTQ on the model 104. The model 104 can be an untrained model, and the quantization platform 202 can perform QAT (the PTQ and QAT are further described below) upon receipt of the untrained model 104.

The quantization platform 202 can receive a dataset including configuration parameters (hereinafter referred to as the configuration file 204, for simplicity). In example embodiments, the configuration file 204 is received from other than that the machine learning framework 102 (e.g., as shown by path 204B in FIG. 2A), or the configuration file 204 can be received from the machine learning framework 102 (e.g., as shown path 204B in FIG. 2A). For example, the machine learning framework 102 can be provided with an add-in, or similar feature to allow the machine learning framework 102 to specify or gather input to specify the configuration file 204 in addition to the model 104. In example embodiments, the platform 202 is integrated or otherwise incorporated with the framework 102, to enable specifying of the configuration file 204 from directly within the framework 102. The configuration file 204 can be generated by an element or process other than is shown in FIG. 2 and provided to the quantization platform 202. For example, at least some of the configuration file 204 can be stored after calibration for a particular hardware configuration, e.g., to be used in subsequent instances of quantizing a different model 104 for a similar hardware configuration.

The configuration file 204 can take a variety of different forms include a variety of configuration parameters. For example, the configuration file 204 can be a plain text file, linked to, or otherwise associated with the model 104. The configuration file 204 can also include a variety of different configuration parameters, as will be discussed herein. The configuration file 204 can reflect input received from a user, such as the results of one or more prompts for input, or an employee or individual related to the quantization platform 202 entering input, etc. To particularize a single example, the quantization platform 202 can generate prompts for configuration parameters upon receipt and analysis of the model 104. This can ensure that each received model has a corresponding configuration file 204. The configuration file 204 can be a single file, with a single format, or multiple files (e.g., one configuration file can include parameters related to training, while another configuration file can include parameters for implementation) with multiple formats, or data stored to be related to part of a larger system (i.e., the parameters are integrated within another file or process), etc.

The quantization platform 202 receives the model 104 and the configuration file 204 and performs one or more quantization processes to generate a smaller neural network 205. The quantization processes can be based on the configuration file 204, or the quantization processes can be implemented independent of the configuration file 204. A main goal of quantization is to reduce model 104 precision and complexity while preserving accuracy.

Quantization can be applied to a model 104 after or while training. Quantization after training (post-training quantization, or PTQ) can be done statically or dynamically. In static PTQ, weights are quantized ahead of time, using a calibration process on the validation set to compute a scale and bias for the activations. In dynamic PTQ, much like static PTQ, the weights are quantized ahead of time, but the activations are dynamically quantized at inference. Dynamic quantization is useful for models where model execution time is dominated by the time it takes to load weights for the model e.g., LSTM [30].

Quantization can also be learned by the platform 202 or framework 102. In quantization-aware training (QAT) [6], the training will encourage the generation of a smaller model 205 that represents parameters with a pre-defined precision. Compared to PTQ, QAT yields better accuracy. On the other hand, QAT requires more training sessions to learn the quantized parameters.

In example embodiments, the quantization platform 202 implements QAT that can quantize models 104 down to 3 bits, 2 bits or 1-bit smaller models 205, as well as mixed precision smaller models 205 (i.e., different quantization techniques or configurations can be applied to different portions of the network 104). For example, in an example QAT, an example model 104 (represented at least in part by input tensor t) can be quantized as follows:

$$\overline{t} = \vert clip ( \frac{t}{s} , - {Q}_{N} , {Q}_{P} ) \vert \qquad ( 1 )$$

Where, t̅∈ [symbol] is the quantized tensor (the smaller neural network 205), t∈ [symbol] is the input tensor (the model 104) and s∈ [symbol] is a scaling factor. To quantize the input tensor t with b bits, Q_{P}=2^{b-1}−1 and Q_{N}=2^{b-1} represent the clipping limits. In example embodiments, the clipping limits are configuration parameters within the configuration file 204.

Given equation (1) above, the quantization error can be computed as below:

$$\hat{t} = \overline{t} \times s , {error}_{q} = t - \hat{t} \qquad ( 2 )$$

During training, the quantization algorithm therefore learns the scaling factor(s) so that the quantization error, error_{q}, will be minimized. In example embodiments, the configuration file 204 specifies an acceptable error.

Referring again to FIGS. 2A, 2B, and 2C, in at least some example embodiments, the configuration file 204 includes at least one configuration parameter based on the runtime platform 208 (e.g., identifying limitations of the runtime platform). For example, the configuration file 204 can specify at least one of a target device architecture, which may indicate available operators 210. The configuration file 204 can also include parameters indirectly related to the runtime platform 208. For example, the configuration file 204 can include parameters representative of a target latency, or a target accuracy (e.g., an allowable error) for implementing the model 104 on the target device. These parameters can influence, for example, training of the model 104 by the platform 202 to achieve the desired parameter. In example embodiments, the indirect parameters can influence other training parameters used by the platform 202, such as a smaller model 205 resulting model layout.

As alluded to above, because of the configuration file 204, the platform 202 can calibrate one or more training processes to ensure the generated model 205 satisfies the configuration file 204. For example, the platform can generate the model 205 so that the model 205 stores or generates data in a format accepted by the target architecture (e.g., single-precision floating-point format, also sometimes referred to as FP32), or generates the model 205 that can be implemented with the operators available on the target architecture. In at least some contemplated scenarios, the configuration file 204 can include one or more training datasets as configuration parameters to facilitate the training. For example, the provided training data, or validation data, or both, can be used by the quantization platform 202 to further train, or train from first instance, the model 104 in a quantization-aware manner (e.g., via QAT). In example embodiments, the platform 202 performs QAT to enable the generation of mixed precision models 205.

As will be discussed herein, the quantization platform 202 can be coupled with a runtime (e.g., runtime 208) to efficiently implement the quantized model 205 on the target architecture.

Referring now to FIG. 2B, the system 212 shows embodiments where a second configuration file 207 is generated by the platform 202, which configuration file 207 is used by the compiler 206 to generate the compiled code 212.

The configuration file 207 can include data that specifies one or more implementation parameters. For example, the configuration file 207 can include parameters which specify an order of implementing operators 210 in a runtime environment, a level of precision for one or more model 205 components (e.g., weights or activations), an encoding scheme, or a data format into which model 205 components should be cast, a composition of operators (e.g., the platform 208 can include a plurality of operators 210, and the configuration file 207 can specify a subset to use), etc. The configuration file 207 can include parameters that specify a particular runtime platform 208 (e.g., a runtime that includes necessary operators 210), etc.

In example embodiments, at least some of the data previously described as part of the configuration file 204 is instead provided in configuration file 207. For example, in example embodiments, only a single configuration file 207 is used to implement a quantized model 205 of the model 104 with the platform 208. Particularizing the example, the platform 202 can be implemented with a pre-determined configuration, which includes data similar to configuration file 204, and take only the model 104 as an input to generate the configuration file 207 and smaller model 205. This scenario can arise, for example, where different models 104 are being quantized for the same target device (e.g., updated models, etc.). For clarity, the configuration file 207, in this scenario, is responsive to the limitations (e.g., identifying runtime platform 208 limitations, such as operators) that otherwise would have been identified in the configuration file 204.

The compiler 206 receives the smaller neural network 205 from the quantization platform 202 and converts the smaller neural network 205 into compiled code 212 (e.g., binary code). In example embodiments, the compiler 206 is a custom compiler configured to interface with the quantization platform 202, or the compiler 206 is configured to compile code for a variety of architectures. For example, the compiler 206 can be a complier that supports both 32 bit and 64 bit Arm architectures. The compiler 206 can also be, or incorporate aspects of an existing, known compiler, such as compiler 104. For clarity, it is understood that the compiler 206 can run on a device which will implement the model 205, or on another device and then transfer the compiled code 212 to a device that will implement the model 205 via the output compiled code.

The compiler 206 uses the configuration file 207 to define one or more operators 210 to perform one or more operations represented by the model 205 (e.g., matrix multiplication). For example, the compiler 206 can generate compiled code 212 that instructs the platform 208 to use a first operator 210a for a first type of operation, or that instructs the platform 208 to use a first operator 210a for operations to implement a first layer of the model 205 (with another operator 210b being used for other layers of the model 205), or that instructs the platform 208 to use different operators for different processor cores, or that instructs the platform 208 to use a particular operator 210 to accommodate a particular data type, etc.

The runtime platform 208 receives, or is provided with, the compiled smaller neural network 205, i.e., the compiled code 212. An inference engine of the runtime platform 208 implements the compiled code 212 on a processor (not shown) with the use of one or more operators (e.g., the shown operators 210a, 210b . . . 210n). Despite the operators 210 being shown as separate from the runtime platform 208, it is understood that the operators 210 can be part of the runtime platform 208. The operators 210 can include one or more custom operators (e.g., operator 210a), or more than one existing or well-known operators (e.g., operator 210b . . . 210n).

The operators 210 represent instructions for the processor to implement the compiled code. While beyond the scope of this disclosure, it is known that different operators perform with different efficiency. For example, different operators 210 may require less access to memory to perform certain computations. The operators are alternatively referred to as kernels, an example of which is a convolution kernel.

In an example embodiment, custom operator(s) 210a within the inference engine and runtime platform 208 can be defined using low-level assembly or intrinsics such as the Neon vectorized instruction set for Arm, which may accelerate execution of model 104 intended to be implemented with the custom operator 210a.

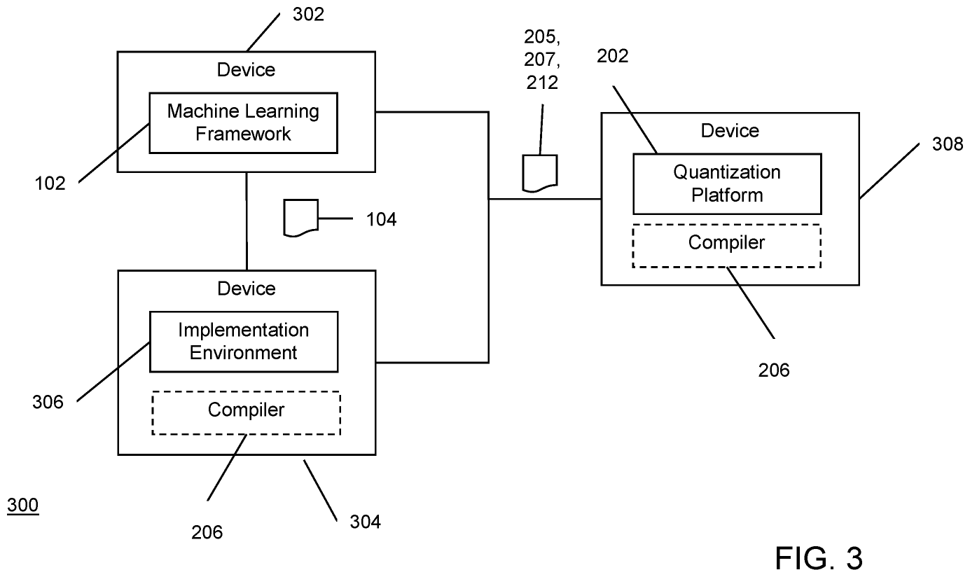

The inference engine and runtime platform 208 can target specific hardware platforms and architectures. For example, the inference engine and runtime platform 208 can be configured for Armv7 and Armv8 backends. In example embodiments, the runtime platform 208 is configured for target hardware, whereas the compiler 206 can run on either a host or target device (as shown in FIG. 3).

The platform 208 can comply with the parameters set out in the configuration file 207. For example, aspects of the platform 208 can be instantiated such that the operating instance of the platform 208 supports operators or data formats specified by the configuration file 207. In another example, and already instantiated platform 208 can be configured to receive additional instructions (e.g., an update) to support parameters (e.g., a new operator 210) specified in the configuration file 207.

Referring now to FIG. 2C, an example system 214 for quantizing a neural network for low-bit environments is shown. The platform 202 receives no information from the framework 102 other than a model 104. The quantization platform 202 thereafter quantizes the model 104 according to stored configuration parameters. Optionally, the platform 202 can have multiple pre-set configuration parameters for different target device architectures and select the appropriate set upon receiving a configuration file 204C specifying the target device architecture.

The platform 202 generates the smaller model 205, and the configuration file 207 for the compiler 206.

The compiler 206 uses the parameters in configuration file 207 to generate compiled code 212 of the smaller model 205. The compiled code 202 includes instructions that, when interpreted by the runtime platform 208, cause the processor to perform in accordance with the parameters in the configuration file 207.

Referring now to FIG. 3, an example computing environment for implementing neural networks is shown. In the shown embodiment, a first device 302 is used to generate the neural network model 104 within the framework 102 (or another framework). For example, this device 302 can be operated by a third-party service provider that builds large machine learning models, or by a business interested in creating models 104 for different devices, etc.

The model 104 can be sent to the device 304. The device 304 may be intended to run the model 104 in the implementation environment 306 (which can include the platform 202 and the platform 208), or the device 304 may be a device acting as an intermediary (e.g., a server) to transfer the model 104 to another device for implementation (e.g., a server of an enterprise which is used to receive and implement models 104), etc. The device 304 can have thereon the compiler 206 and the runtime platform 208, which can be instantiated on the device 304 or can at least in part be transmitted to the device which will implement the model 104.

The device 304 can determine that the model 104 needs to be further quantized (e.g., via QAT) for implementation, and transfer the model 104 to a third device 308 for training, or quantization. The device 308, for example, can be a device 308 of a separate quantization service provider. The device 308 can quantize the model 104 into the smaller model 205 and a related configuration file 207 with the quantization platform 202, and in example embodiments can use the compiler 206 to generate the compiled code 212 for later use by, for example, the implementation environment 306.

It is understood that the delineation between devices in FIG. 3 is merely illustrative. For example, this disclosure also contemplates example embodiments where one or all the devices 302, 306, and 308 are operated by the same provider, or are the same device, or combinations thereof (e.g., device 302 generates the compiled code 212 to be implemented on the device 306). Similarly, the order of communications described in respect of FIG. 3 is also non-limiting. For example, the device 302 can transfer the model 104 directly to the device 308 for quantization into the smaller model 205 and for generation of the configuration file 207.

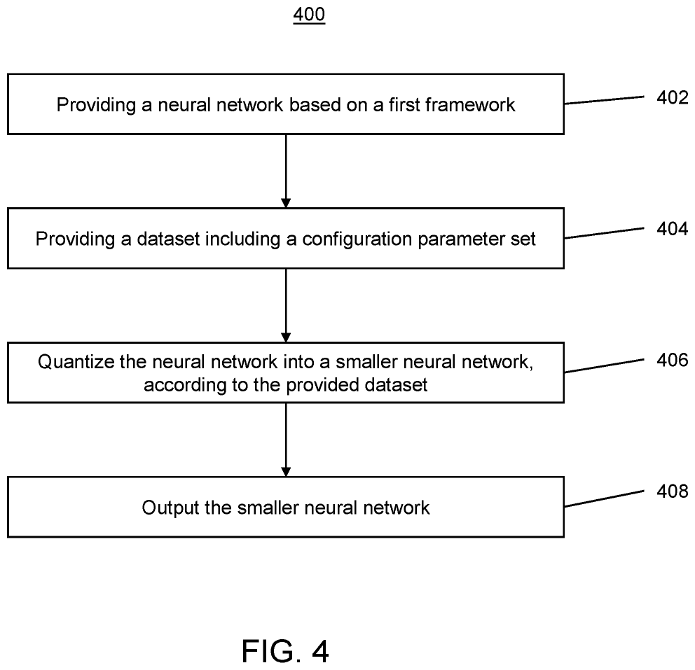

Referring now to FIG. 4, an example method 400 for quantizing neural networks for low bit environments is shown. In describing FIGS. 4, 5, and 6, reference will be made to the preceding figures. It is understood that any such reference is non-limiting, and merely illustrative.

At block 402, a neural network (e.g., model 104) is provided. The neural network can be generated with a known machine learning framework (e.g., framework 102), or the framework can be a custom framework (not shown).

Providing includes instances where the neural network is transmitted to a device (e.g., device 308) which quantizes the neural network, or having the neural network created on a device (e.g., the model 104 is saved on the device after being created on the same device), etc.

At block 404, a dataset including one or more configuration parameters (e.g., the configuration file 204) is provided. Similar to block 404, the term providing can include a variety of different scenarios. In example embodiments, the dataset is actively solicited. For example, upon receiving the model 104, the platform 202 can be configured to parse the model and provide a prompt or other type of input mechanism to have the user specify at least some configuration parameters of the dataset. To particularize the example, the platform 202 can enable the user to enter layer by layer configuration parameters after parsing an input model 104.

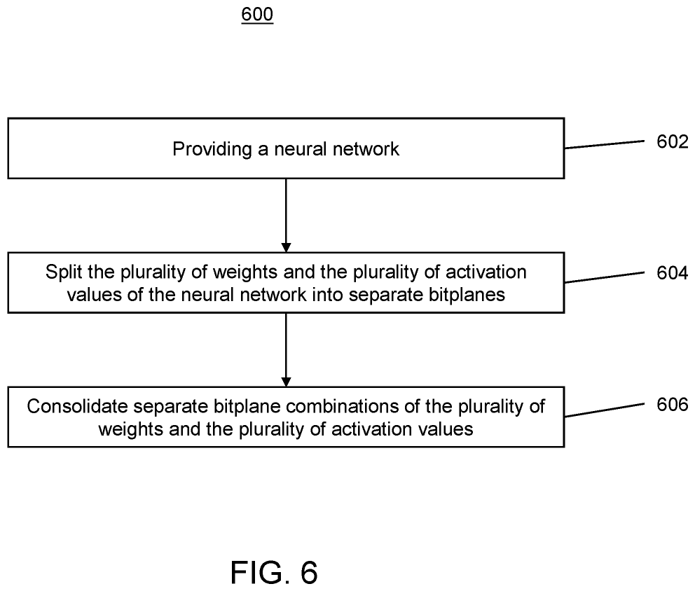

The configuration parameters included in the dataset can be a subset of a plurality of configuration parameters for quantizing neural networks. For example, there may be a plurality of operators 210 which are capable of being used, and an operator 210 may be more desirable (e.g., more efficient), and the configuration parameters to implement that operator 210 can be selected from the group of parameters relating to operators 210. To particularize the example, the operator 210 discussed in respect of FIG. 6 may be preferred for portions of a neural network that are quantized for low precision, and that operator may be selected based on the quantization which requires more efficient inference.

As alluded to above, the dataset includes configuration parameter(s). The configuration parameters can relate to (but are not limited to): a precision of any one of the weights 116, the activation function 120, the activation threshold 122, etc., of neurons of the model 104. In example embodiments, the configuration parameters relate to selective application of the precision related configurations to different parts of the model 104. For example, different configuration parameters can be applied to different subsets of the neurons of the model 104 (e.g., the precision related parameters can be applied on a layer-by-layer basis, such as only impacting only certain sized layers), and to subsets of neuron properties (e.g., configuration parameters are only applied to weights), etc.

The configuration parameters can include a parameter(s) which influences training the model 104, such as additional training pursuant to QAT. For example, the configuration parameters can specify a target precision of the model (or parts of the model), a target accuracy, or a related parameter (e.g., the clipping limits), etc.

The configuration parameters can include a parameter(s) which impacts the resulting smaller model 205 directly. For example, the parameter can specify a resulting layout of the model 205. More particularly, the parameter can place a limit on the number of convolution layers, the number of neurons, the maximum size of a layer, the maximum degree of connectivity of a neuron or layer, etc.

The configuration parameters can include a parameter(s) which impacts the implementation of the model 205 by the runtime platform 208. For example, the configuration file 204 can include a parameter which specifies an encoding scheme for any one of the smaller model 205 equivalents of the weights 116, etc., of neurons of the model 104, or the neurons of model 104 itself. In at least some example embodiments, the parameter specifies that the encoding is one of unipolar, bi-polar, etc. The configuration parameters can be related to a relative order to apply operators 210 in the platform 208 (e.g., different operators are used for different layers depending on their expected properties). To provide an example, the configuration parameters can map or cast the default operators expected to be used by an existing machine learning framework 102 to custom operators 210 to be applied by the platform 208 considering the quantization. This can support a more streamlined and automated process, where a first user familiar with generating models 104 can continue to use familiar frameworks 102, and rely upon the quantization platform 202, complier 206, and/or runtime platform 208 to quantize the network effectively for a desired hardware configuration.

At block 406, the neural network 104 is quantized into the smaller neural network 205, at least in part according to the configuration file 204. For example, the model can be quantized to the desired precision, the weights encoded in the desired manner, etc. In example embodiments, quantization includes training the model 104 with the configuration parameters of the configuration file 204 responsive to QAT.

In example embodiments, the platform 202 also outputs a configuration file 207, or at least in part generates the configuration file 207. For example, the QAT implemented by the platform 202 may be implemented solely based on a desired accuracy and target platform. As a result, after performing QAT, the platform 202 can generate the configuration file 207 that includes layer-by-layer specification of precision, operators, etc., that need to be specified to implement the smaller model 205 while still satisfying the constraints of the configuration file 204.

In example embodiments, the model 104 can be quantized without reference to the configuration file 204. For example, the configuration file 207 can include sufficient definition of parameters which can are able to be interpreted by the runtime platform 208 (e.g., the platform 208 is a default platform which is facilitated by default by the platform 202 in generating the configuration file 207). In example embodiments, the parameters within the configuration file 207 are provided, and not generated by the platform 202.

At block 408, the smaller model 205 is output. In example embodiments, the configuration file 207 is also output. The term output can refer to a variety of different actions. For example, outputting can include storing the smaller model 205 and configuration file 207 in memory, transmitting the smaller model 205 and configuration file 207, to another device (e.g., as in FIG. 3), etc.

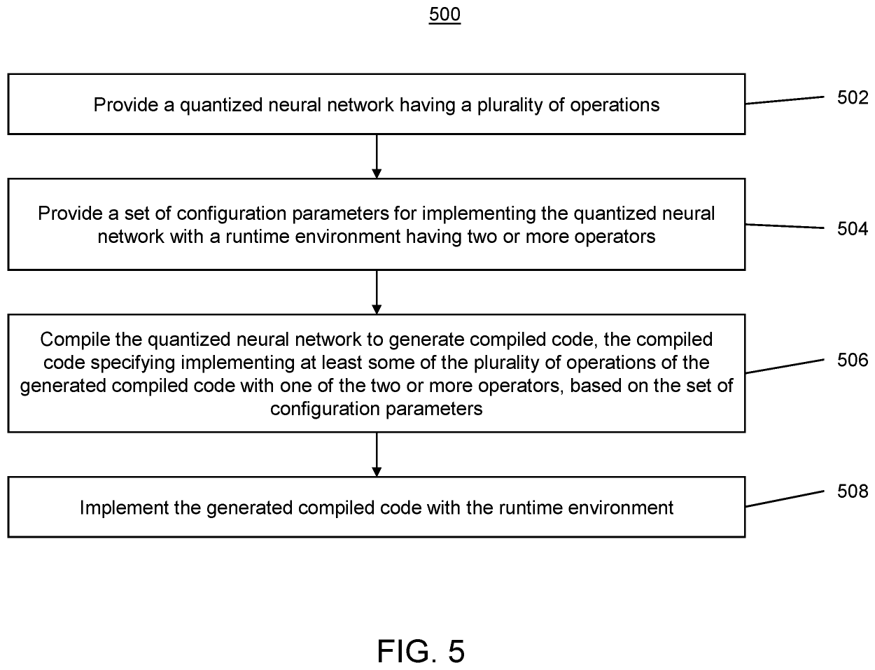

Referring now to FIG. 5, an example method 500 for deploying quantized neural networks is shown.

At block 502, a quantized neural network (e.g., smaller network 205) having a plurality of operations is provided. The operations can include matrix multiplications, etc.

At block 504, a set of configuration parameters (e.g., via configuration file 207) for implementing the quantized neural network with a runtime environment (e.g., platform 208) having two or more operators (e.g., operators 210) is provided. The operators can include one or more operators for implementing operations for ultra-low bit environments, such as a customer operator. For example, in at least some example embodiments, the operator 210 for running ultra-low precision quantized models with high performance on Arm CPUs is specified in the dataset, based on the target hardware configuration. The operators can include custom operators, including optimized INT8 kernels and binary convolution layers using XNOR and popcount operations, lookup tables (LUTs). The operators can include well known or existing operators, which may be used, for example, in instances where the configuration parameters specify a mixed-precision implementation of the model 205 which requires well know or existing operators. In at least some example embodiments, the configuration parameters positively identify that mixed precision is required, or the configuration parameters can indirectly specify a mixed-precision implementation by simply specifying different precision for different layers of the model 205.

At block 506, the quantized neural network is compiled to generate compiled code (e.g., compiled code 212). The compiled code specifies implementing at least some of the plurality of operations incorporated within the generated compiled code with the operators identified within the configuration parameters provided in block 504.

In example embodiments, block 506 includes casting elements (e.g., weights or activations) of the quantized neural network from a first data type (FP32) into a second data type. The elements can be cast to so that they are compatible with the operators specified in the configuration parameters specified in block 504.

In at least some example scenarios, the quantized neural network received in block 502 is the result of a model (e.g., model 104) being generated in a framework 102 that is itself associated with, or configured to operate, with a target architecture. This disclosure at least in part relates to being able to implement that model 104 on architecture other than the framework 102 target architecture. That is, the configuration file of block 504 can be used to adapt the quantized model 205 to be suited to different, ultra-low bit architectures (i.e., different than the first target architecture of the framework 102) not contemplated by the framework 102. The configuration file can accomplish this by enabling converting operations of the model 104, into operations for the quantized model 205. The quantized operations can be implemented by custom operators 210 of the platform 208, or by a combination of custom and known operators. For example, a single custom operator 210 can potentially unlock a plurality of quantization options by enabling performance of more intensive operations associated with the model 104 on the ultra-low bit architectures.

At block 508, an inference engine of the runtime platform 208 is used to implement the complied code in accordance with the dataset. For example, the inference engine can retrieve a subset of the provided operators of block 504 responsive to an ultra-low bit environment for use, and implement the compiled code 212 therewith.

The inference engine can implement different operators from an available plurality of operators for various parts of the compiled code. For example, different operators can be applied by the inference engine because of the layer-by-layer targeted levels of precision specified in the configuration file 207. In at least some example embodiments, the inference engine applies both custom and known operators. For example, where only certain parts (e.g., layers) of the model are quantized, the inference engine may apply custom operators to the quantized parts of the model.

The runtime platform 208 can be updated with new or updated operators 210 for use with the inference engine. For example, new custom operators can be developed and incorporated into the runtime platform 208. One example of installing new operators includes retrofitting existing platforms 208 provided by a manufacturer to enable performance of the methods described herein. In this way, the platforms 202, 208 can together be used as a framework-agnostic deployment of models on hardware, and for example, make mixed precision model training and execution significantly more accessible.

Relatedly, the runtime platform 208 can be configured to be operable in a variety of different implementation environments. For example, the runtime platform 208 can have the ability to operate on different hardware configurations, and user input can thereafter be used to select the relevant hardware configuration for selecting configuration parameters such as operators, etc. Similarly, the runtime platform 208 can be configured to process complied code received from a plurality of different compilers 206.

It can be appreciated that a system can be configured to implement both the example method 500 and the example method 600 as part of an end-to-end pipeline. For example, the system can be configured to automatically receive the models 104, receive or solicit a configuration file, and thereafter implement the received models 104 according to the received configuration file with the runtime platform 208. For example, in a particular configuration an end-to-end pipeline combines all the steps required to quantize and run a CNN based model on the runtime 208. More particularly, the platform 202 can automatically quantize a trained full-precision CNN down to 2 bits and passes it to compiler 206 that then compiles the quantized model and generates a dlrt file ready to be deployed and executed with runtime 208.

In another example, the platform 208 can integrate into, or provide, an automated framework for the deployment of mixed precision and ultra-low bit quantized models on target platforms. The precision, layout and encoding scheme for the weights and activations can be individually specified for each convolution layer in the model. The platform 208 lowers each convolution layer to a supported optimized operator corresponding to the specified precision, layout and encoding scheme. The platform 208 can support FP32, INT8, 2 A/2 W and 1 A/2 W precisions for convolution layers with binary (1 A/1 W, as that term is described herein) and optimized INT8 operators currently under development. NCHW and NHWC layouts are supported for activations while OIHW and HWIO layouts are supported for weights. For the bitserial (and binary) quantized layers, the encoding scheme of the weights and activations can be either unipolar or bipolar.

In example embodiments where parameters are specified for every convolution layer, the specification of these parameters for every convolution layer enables the platform 208 to take a mixed precision model in a standard format such as ONNX and convert the convolution layers in the model to the valid operators for that configuration. This removes the need for custom convolution operators to be added in the machine learning frameworks being used to train, quantize, and export the model. The model can be exported with the default convolution layers for the machine learning framework of choice while keeping the weight and activation values in floating-point; the platform 208 casts the data and parameters to the required precision and converts the convolution layers to the corresponding optimized operators. The platform 208 therefore provides an inference engine that allows such framework-agnostic deployment of mixed precision models.

In example embodiments, the operator(s) 210 can include low-level operator implementations using intrinsics from the Neon vectorized instruction set for both Armv7 and Armv8 architectures to target 32-bit and 64-bit Arm CPU devices. Implementation within the runtime platform 208 can include efficient tiling and parallelization schemes to improve upon the performance of the vectorized kernels.

Referring now to FIG. 6, an example method 600 for performing convolutions is shown.

At block 602, a neural network comprising a plurality of neurons associated with a respective plurality of weights and plurality of activation values is provided.

At block 604, the plurality of weights and the plurality of activation values provided in block 602 are split into separate bitplanes.

At block 606, the plurality of weights and the plurality of activation values are consolidated for separate bitplane combinations. In example embodiments, the one of the plurality of weights and the plurality of activation values are encoded with bipolar encoding (e.g., the plurality of weights or the plurality of activations). In example embodiments, one of the plurality of weights and the plurality of activation values are encoded with unipolar encoding (e.g., the plurality of weights or the plurality of activations).

The consolidating can be based on the bitserial dot product between the plurality of weights and the plurality of activation values.

To provide a particularized example of method 600, an operator 210 can be configured perform convolutions using bitserial computation where popcount and bitwise operations are utilized to calculate the dot products of the low bit weight and activation values (e.g., weight and activation values 116 and 112, respectively).

In implementations where multi-bit weights and activations (W bits for weights and A bits for activations) are supported, the weights Wand activations A can be split into separate bitplanes, and their dot products across all the bitplane combinations can thereafter be consolidated (e.g., summarized) as shown below:

$$W \cdot A = {\sum }_{i = 0}^{w - 1} {\sum }_{j = 0}^{a - 1} ( POPCOUNT ( W [ i ] \& A [ j ] ) ≪ ( i + j ) ) \qquad ( 3 )$$

To preserve accuracy during quantization, while still quantizing the network to an acceptable degree, differential encoding of the weights Wand activations A can be used. For example, in embodiments, bipolar encoding can be applied to the weights Wand unipolar encoding for activations A. With bipolar encoding, the weights can therefore have both negative and positive values. To particularize an example, using 2-bit weights with bipolar encoding, each parameter can have one of the values in {−2, −1, 0, 1}. For the multi-bit case using this unipolar-bipolar encoding scheme, the bitserial dot product computation now becomes:

$$W \cdot A = {\sum }_{i = 0}^{w - 1} {\sum }_{j = 0}^{a - 1} ( - {1}_{( i = w - 1 )} + {1}_{( i \neq w - 1 )} ) \times \qquad ( 4 )$$

$$( POPCOUNT ( W [ i ] \& A [ j ] ) ≪ ( i + j ) )$$

This described multi-bit case with variation in encoding can give better accuracy for the quantized layers at the expense of extra multiplication operations. Experimental testing indicates that this approach is close in computational complexity to the single encoding solution set out below, while exhibiting a significant improvement on the unipolar-bipolar dot product computation in [7] that uses two popcount operations rather than one.

In contrast to the above, in example embodiments the weights and activations are configured for 1-bit operations, with unipolar encoding where each bit can take on the values {0, 1}. The bitserial dot product can therefore be computed with the following equation:

$$W \cdot A = POPCOUNT ( W \& A ) \qquad ( 5 )$$

### Experimental Benchmarks

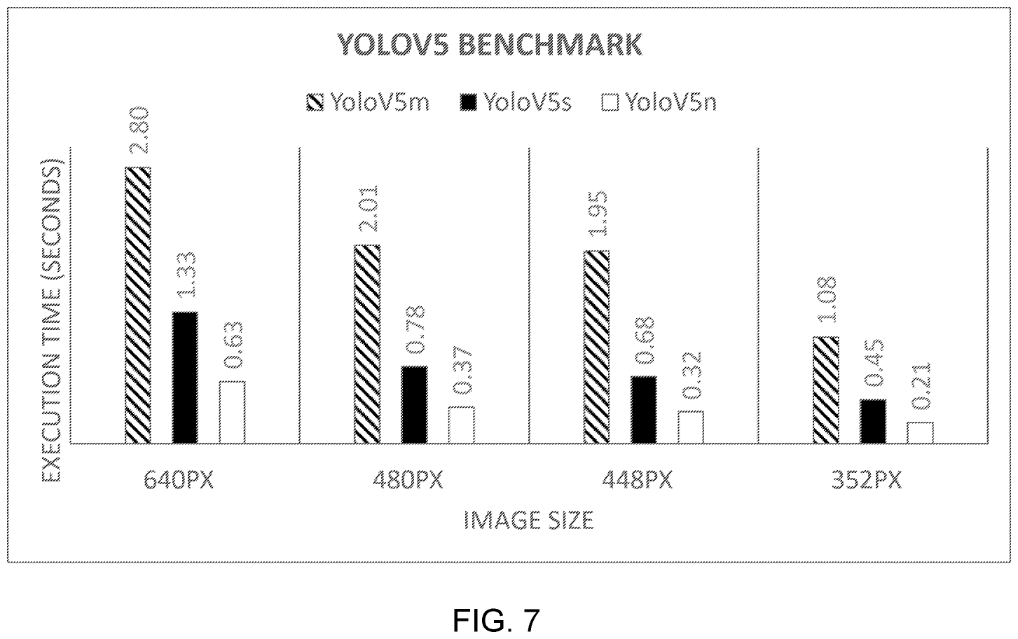

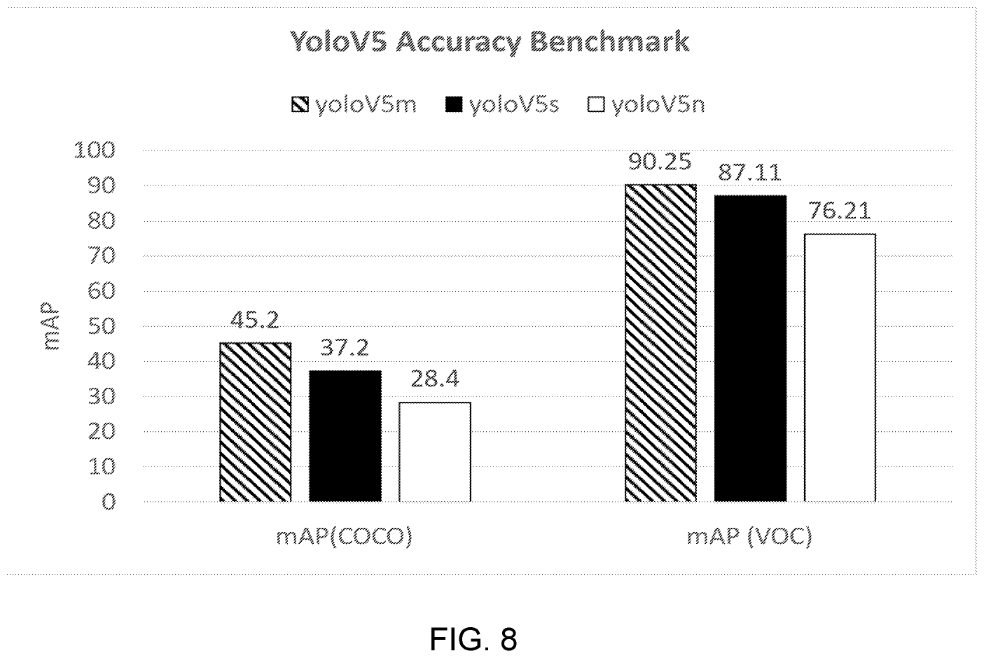

An experiment was conducted to benchmark the state-of-the-art object detection models implemented on a Raspberry Pi 4B platform (Arm Cortex A-72). The experiment indicates that unless a very compact model (YOLOv5n [1]) combined with a very low-resolution input image (less than 300px), is used, it is difficult if not impossible to achieve more than 4-5 FPS, even with 8-bit quantization. The experimental results are shown in FIG. 7. The speedup from using YOLOv5n, however, has an expensive tradeoff, where the graph in FIG. 8 shows the accuracy drop on YOLO Variants for VOC and COCO datasets.

The high latency and low throughput for current deep neural networks on commodity CPUs like the Cortex-A72 in the Raspberry Pi 4B demonstrates the harsh limitations of AI inference on low power and affordable processors. Despite there being billions of devices powered by ARM Cortex-A CPUs, even the latest quantization techniques did not provide sufficiently low latency numbers for practical applications. Although reducing the model parameters from 32 bits to 8 bits results in respectable speedup without a significant loss in accuracy, it may not enough to run these models on such small footprint hardware. Furthermore, many of the compact networks [2] designed for these devices were not accurate enough, including potentially the smaller variations of YOLOv5n [1] as shown in FIG. 8.

### Experimental Results

To provide a brief overview, in a disclosed experiment, the ResNet18 model 105 was run on the low-power Arm Cortex-A53 CPU in the Raspberry Pi 3B+, for an example implementation with the unipolar-bipolar encoding scheme described herein. The aforementioned configuration realized speedups of up to 2.9× on 2-bit and 4.4× on 1-bit over an optimized floating-point baseline, improving upon the results published in prior works [7].

Additionally, experiments were conduced on object detection models in a similar fashion and achieved speedups of up to 2.2× and 3.2× over TFLite with XNNPACK [10][12] and ONNX Runtime [11], respectively, for both YOLOv5s and YOLOv5m [1] on the Arm Cortex-A72 CPU in the Raspberry Pi 4B [19].

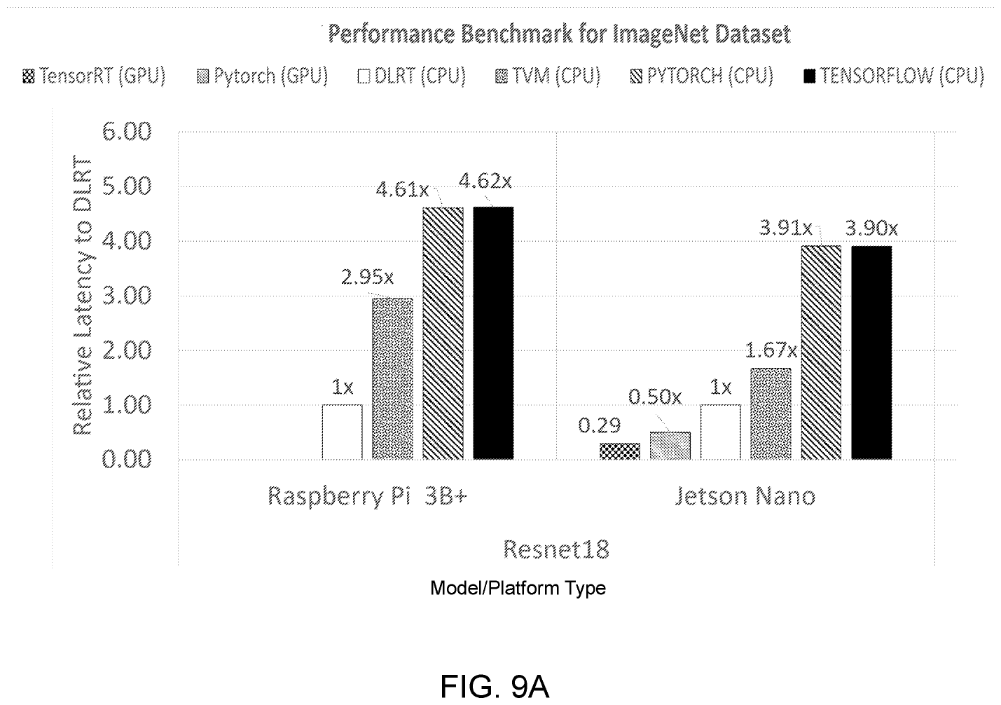

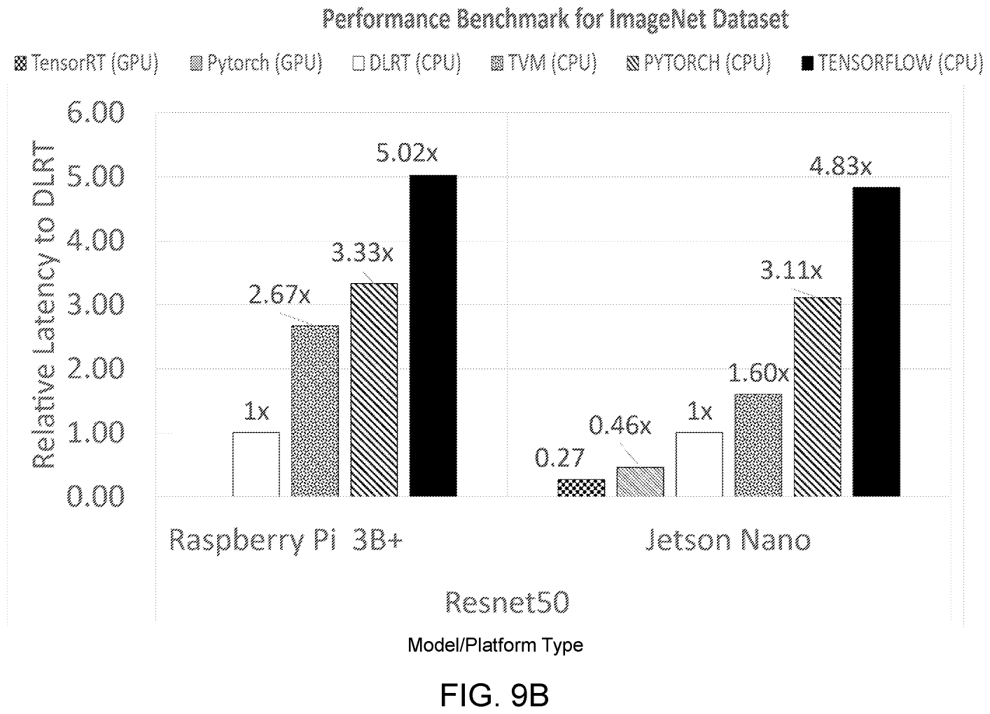

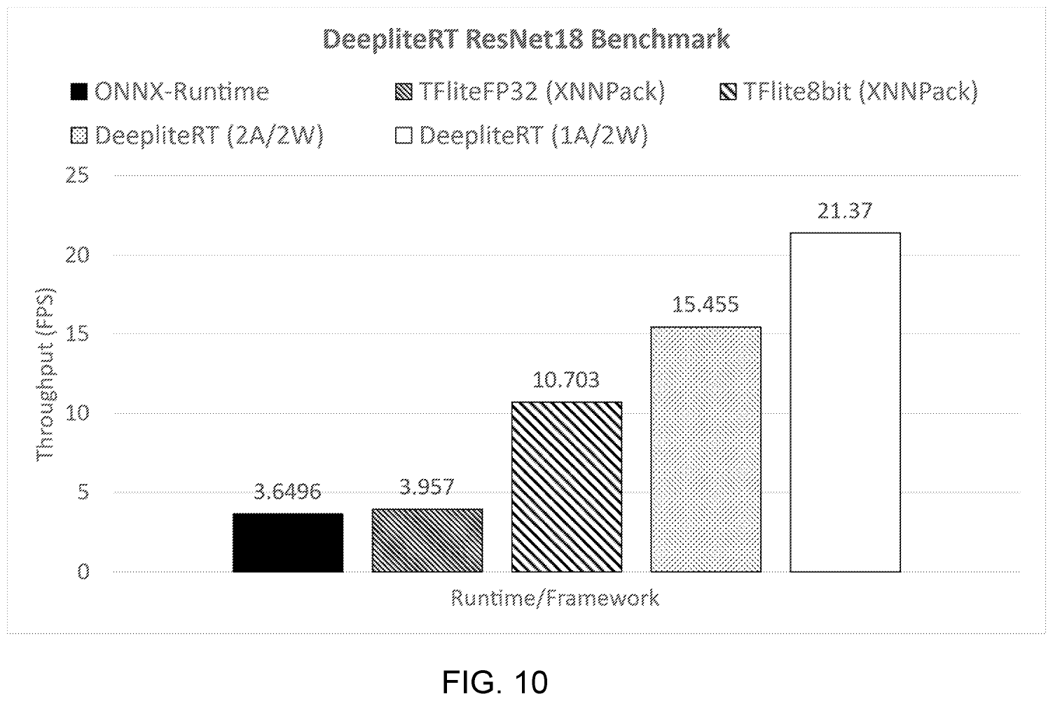

More particularly, the accuracy and inference time of ultra-low bit models, quantized in accordance with the methods discussed herein, for classification and object detection tasks was evaluated. For classification tasks, the ResNet18 [3] and ResNet50 [3] models were applied to ImageNet dataset, and ResNet18 model was applied to VWW [8] dataset. A benchmark graph indicating the performance of models generated by the different machine learning frameworks is shown in FIGS. 9A and 9B. FIGS. 9A and 9B show the accuracy/performance benchmark of the runtime 208 on ResNet18 and ResNet50 models on ImageNet dataset, where lower bars mean faster acceleration or lower inference time. In the disclosed experiments, the models were generated in the known machine learning frameworks 102, including TensorFlow [15], PyTorch [16], ONNX Runtime [11], TVM [28], TFLite [10], and in the disclosed runtime platform 208 (shown in the following FIGS. as DeepliteRT, or DLRT). The proposed runtime 208 is only 50% slower compared to embedded GPU performance. The Restnet18 model was also evaluated on different frameworks as shown in FIG. 10. In FIG. 10, the runtime 208 (again, shown as DeepliteRT) performance benchmark for ResNet18 with VWW [8] dataset 224px image is shown in comparison to other frameworks, for both the 2 A/2 W and the 1 A/2 W approaches.

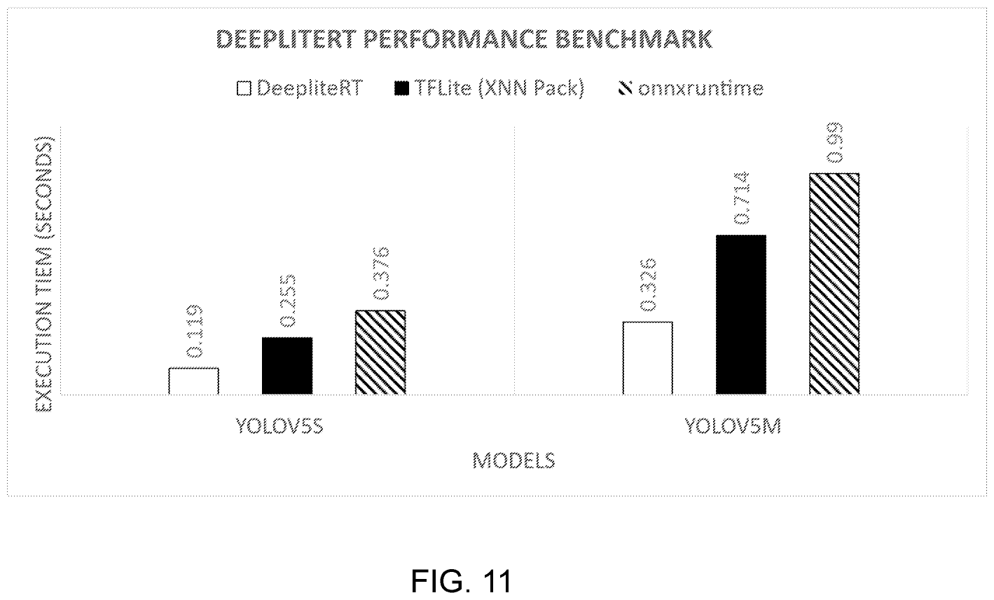

Pipelines according to the disclosure herein were benchmarked on VGG16-SSD [17], YOLOv5s [1] and YOLOv5m [1] on Pascal VOC [9], and subset of MS-COCO [20] datasets, for object detection. Results are shown in FIG. 11, which shows runtime 208 performance benchmark for YoloV5m and Yolo5Vs, on a 320px image. From FIG. 11, it can be seen that TFLite performs poorly without the XNNPACK delegate and can be even slower compared to the FP32 models.

The target devices (e.g., devices 304) used implementation environments (e.g., implementation environments 306) included the Raspberry Pi 3B+ with 4× Arm Cortex-A53, the Raspberry Pi 4B with 4× Arm Cortex-A72 and the NVIDIA Jetson Nano with 4× Arm Cortex-A57, as indicated.

The Experimental Results shall be discussed below with reference to the model and platform.

### A. ResNet18 on VWW

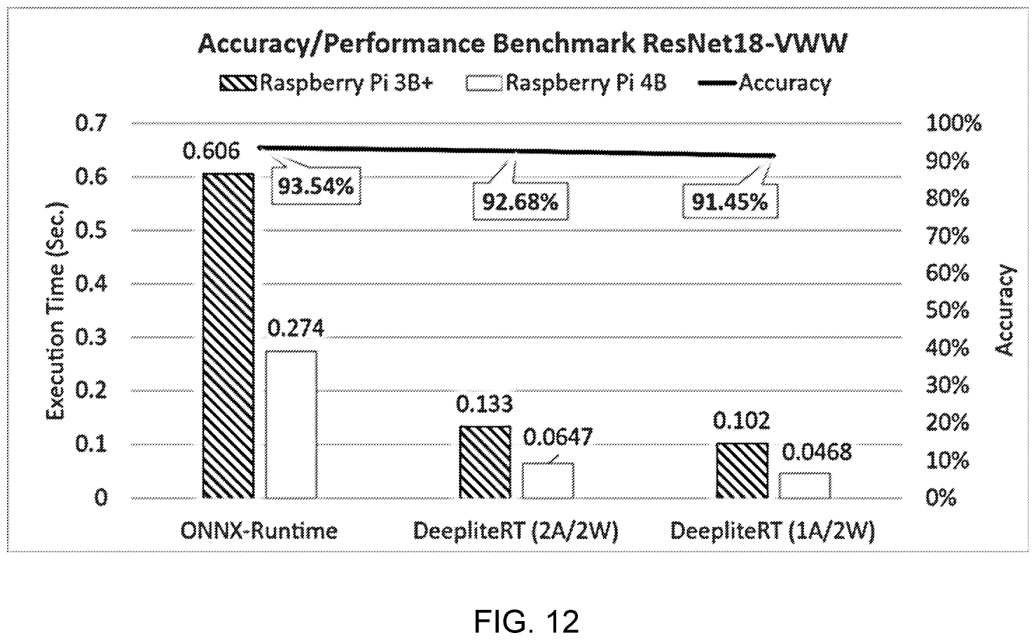

Referring now to FIG. 12, the shown graph illustrates the accuracy-performance trade-off for disclosed runtime and ONNX Runtime on the ResNet18 model trained on VWW dataset for 2 A/2 W (2 bits for activations and weights) and 1 A/2 W (1 bit for activation and 2 bits for weights) precisions. The quantized ResNet18 (i.e., the bars with between 3.5-4 FPS) on VWW dataset achieved 15.58× reduction in model size (see FIG. 10) with 3.75× and 2.90× speedups on Raspberry Pi 3B+ and Raspberry Pi 4B devices, respectively. Moreover, this was achieved with less than a 2% drop in accuracy for the 1 A/2 W configuration and less than a 1% drop in accuracy for the 2 A/2 W configuration.

Implementations using the disclosed runtime 208 were compared to TFLite [10] with XNNPACK [12] for the 2 A/2 W quantized models, and the 1 A/2 W quantized models. The disclosed 2-bit model (whose accuracy is similar to the FP32 accuracy (93.54%) presented in FIG. 12. for ONNX Runtime) has less than 1% accuracy drop while being significantly faster compared to the TFLite INT8 model running on the XNNPACK backend.]

### B. VGG16-SSD on VOC

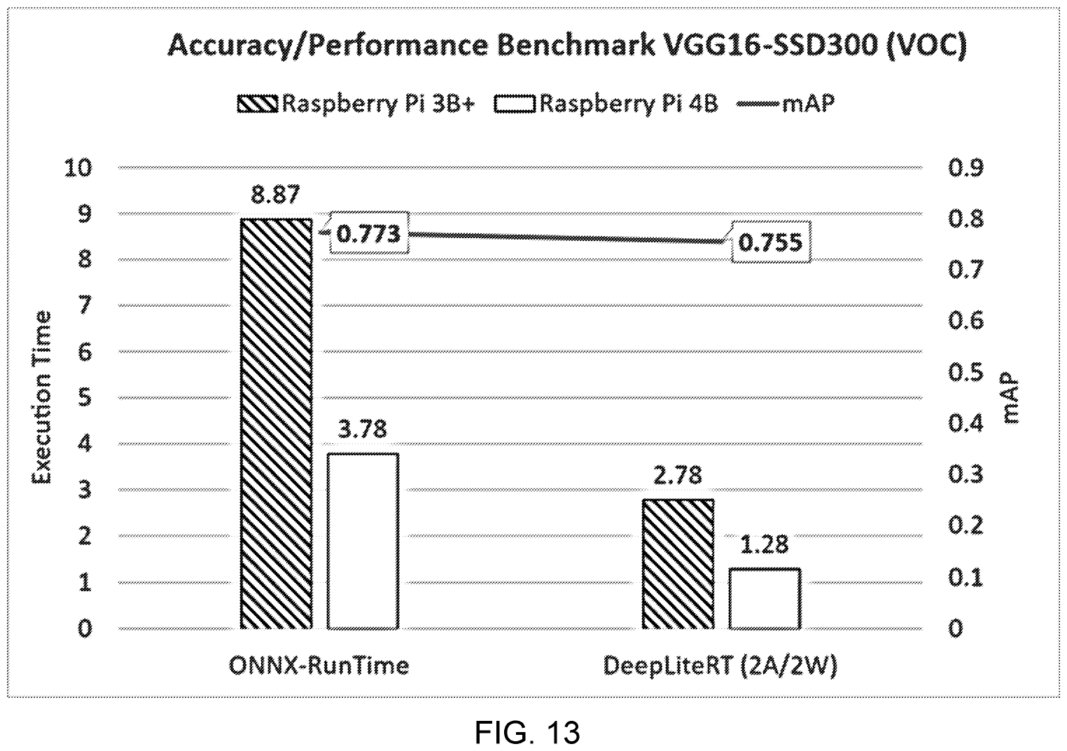

The Single Shot Detection (SSD) [17] model was used with VGG16 [31] backbone as a part of the experimental object detection performance analysis. As evident from the graph in FIG. 13, the runtime 208 achieved 3.19× and 2.95× speedup on Raspberry Pi 3B+ and Raspberry Pi 4B, respectively. FIG. 13 shows accuracy/performance metrics which benchmark the platform 208 on VGG16-SSD300 [17] model on Pascal VOC [9] object detection dataset (2 A/2 W—weights and activations quantized to 2 bits).

The models quantized and implemented as described herein resulted in significant speedup, while the compression came at the cost of less than 0.02 drop in mAP.

### C. YOLOv5s and YOLOv5m on VOC

The experimental classification results indicate the implementations according to the disclosure can achieve state-of-the-art accuracy and latency on Arm hardware with limited computational power, such as the Cortex A-53 in Raspberry Pi 3B+. VGG16-SSD [17] detection results were also promising but even the best performing model on the Raspberry Pi 4B was limited to more than a second for a single inference during experimentation.

To address this challenge, the runtime 208 was extended to support to YOLOv5 [1], a state-of-the-art object detection architecture. To understand how the runtime 208 operated ultra-low precision models compare to TFLite with XNNPACK [10] [12 (FP16 model from Ultralytics repository [1]) and full-precision ONNX Runtime results on Arm CPUs, YOLOv5s and YOLOv5m from the Ultralytics repository was used, and trained on the person class in VOC [9] dataset to enable comparison.

The performance benchmarks show speedups of up to 2.2× over TFLite with XNNPACK [10][12] and 3.2× over ONNX Runtime [11] for both YOLOv5s and YOLOv5m [1] on Raspberry Pi 4B. 9 FPS for YOLOv5s and 3 FPS for YOLOv5m was achieved on this target device with the runtime 208. By combining accurate, SOTA models like YOLOv5 with accessible hardware like the Arm Cortex-A CPU inside the Raspberry Pi [19], new possibilities for vision applications at the edge for the AI community are potentially created.

### D. YOLOv5n on COCO 8 Classes

An extensive evaluation of the disclosed quantization framework and runtime was performed on a subset of MS-COCO dataset. The COCO dataset consists of 80 classes, but it was evaluated on a subset including the classes that are relevant for real life use cases. This subset includes the person, dog, cat, car, bus, truck, bicycle, and motorcycle classes. Table 1 shows the latency improvement of the 2-bit model quantized and implemented according to the disclosure (hereinafter referred to simply as the “quantized model”, for simplicity), and running on an Arm Cortex A-53 processor. Inference time for the quantized model is 2.54× faster compared to the baseline with only an approximately 1% accuracy drop. Since it is extremely challenging to quantize already compact models, a mixed precision approach was used, keeping a few quantization-sensitive layers in FP32 and the rest quantized down to 2 bits. Based on the results, mixed precision ultra-low bit quantization is an effective method to increase speedup of compact models with a minimal drop in accuracy.

TABLE 1
BENCHMARK ON YOLOV5N/COCO-8 CLASSES

| | 352px, ARM Cortex A-53, COCO 8 classes | | |
|---|---|---|---|
| Model | Quantization approach | mAP | Latency (ms) |
| YOLOv5n -FP32 | No quantization | 0.424 | 250 |
| YOLOv5n - | Conservative | 0.414 | 98.371 |
| Mixed-precision | | | |
| (FP32 and 2-bit) | | | |

### Conclusion Of Experiments

This disclosure shows approaches with memory benefits (up to 16× compression with 2-bit quantization), that are complemented by faster arithmetic enabled on low-cost CPUs. The result is 2-5× speedup over existing FP32 and INT8 runtime frameworks, approaching GPU-level latency on a commodity Arm processor as demonstrated by the image classification benchmarks on the Arm Cortex-A57 CPU in the NVIDIA Jetson Nano. Quantization was applied on complex SOTA models including VGG16-SSD, YOLO family and ResNet18/50, and yielded inference acceleration over next-best-alternatives, reinforcing the promise of ultra-low bit CNN models on low-cost CPUs.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the server or user's device, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

### REFERENCES

[1] Glenn Jocher, Ultralytics, (2019), GitHub repository, https://github.com/ultralytics/yolo5
[2] A. G. Howard et al., “MobileNets: Efficient Convolutional Neural Networks for Mobile Vision Applications,” CoRR, vol. abs/1704.04861, 2017, [Online]. Available: http://arxiv.org/abs/1704.04861
[3] K. He, X. Zhang, S. Ren, and J. Sun. Deep residual learning for image recognition. arXiv preprint arXiv:1512.03385, 2015.
[4] A. Sankaran et al., “Deeplite Neutrino: An End-to-End Framework for Constrained Deep Learning Model Optimization,” CoRR, vol. abs/2101.04073, 2021, [Online]. Available: https://arxiv.org/abs/2101.04073
[5] Stefano Markidis, Steven Wei Der Chien, Erwin Laure, Ivy Bo Peng, Jeffrey S. Vetter, NVIDIA Tensor Core Programmability, Performance & Precision (https://arxiv.org/abs/1803.04014)
[6] B. Jacob et al., “Quantization and Training of Neural Networks for Efficient Integer-Arithmetic-Only Inference,” CoRR, vol. abs/1712.05877, 2017, [Online]. Available: http://arxiv.org/abs/1712.05877
[7] M. Cowan, T. Moreau, T. Chen, J. Bornholt, L. Ceze, Automatic generation of high-performance quantized machine learning kernels, CGO 2020: Proceedings of the 18th ACM/IEEE International Symposium on Code Generation and Optimization February 2020 Pages 305-316 https://doi.org/i0.1145/3368826.3377912
[8] A. Chowdhery, P. Warden, J. Shlens, A. Howard, and R. Rhodes, “Visual Wake Words Dataset,” CoRR, vol. abs/1906.05721, 2019, [Online]. Available: http://arxiv.org/abs/1906.05721
[9] M. Everingham, S. M. A. Eslami, L. Van Gool, C. K. I. Williams, J. Winn, and A. Zisserman, “The Pascal Visual Object Classes Challenge: A Retrospective,” International Journal of Computer Vision, vol. 111, no. 1, pp. 98-136, January 2015.
[10] Li Shuangfeng. TensorFlow Lite: On-Device Machine Learning Framework[J]. Journal of Computer Research and Development, 2020, 57(9): 1839-1853.
[11] developers, O. R. (2021). ONNX Runtime. https://onnxruntime.ai/. https://onnxruntime.ai/
[12] Google, XNNPACK, (2019), GitHub repository, https://github.com/google/XNNPACK
[13] Q. Han et al., “Extremely Low-Bit Convolution Optimization for Quantized Neural Network on Modern Computer Architectures,” 2020. doi: 10.1145/3404397.3404407.
[14] J. M. Alarcón, A. N. H. Blin, M. J. V. Vacas, and C. Weiss, Exploring hyperon structure with electromagnetic transverse densities. arXiv, 2018. doi: 10.48550/ARXIV.1802.00479.
[15] M. Abadi et al., TensorFlow: Large-Scale Machine Learning on Heterogeneous Systems. 2015. [Online]. Available: https://www.tensorflow.org/
[16] A. Paszke et al., “PyTorch: An Imperative Style, High-Performance Deep Learning Library,” in Advances in Neural Information Processing Systems 32, H. Wallach, H. Larochelle, A. Beygelzimer, F. d'Alché Buc, E. Fox, and R. Garnett, Eds. Curran Associates, Inc., 2019, pp. 8024-8035. [Online]. Available: http://papers.neurips.cc/paper/9015-pytorch-an-imperative-style-high-performance-deep-learning-library.pdf
[17] W. Liu et al., “SSD: Single Shot MultiBox Detector,” CoRR, vol. abs/1512.02325, 2015, [Online]. Available: http://arxiv.org/abs/1512.02325
[18] S. Yun and A. Wong, “Do All MobileNets Quantize Poorly? Gaining Insights into the Effect of Quantization on Depthwise Separable Convolutional Networks Through the Eyes of Multi-scale Distributional Dynamics,” CoRR, vol. abs/2104.11849, 2021, [Online]. Available: https://arxiv.org/abs/2104.11849
[19] W. Gay, Raspberry Pi Hardware Reference, 1st ed. USA: Apress, 2014.
[20] T.-Y. Lin et al., “Microsoft COCO: Common Objects in Context,” CoRR, vol. abs/1405.0312, 2014, [Online]. Available: http://arxiv.org/abs/1405.0312
[21] I. Hubara, M. Courbariaux, D. Soudry, R. El-Yaniv, and Y. Bengio, “Quantized Neural Networks: Training Neural Networks with Low Precision Weights and Activations,” CoRR, vol. abs/1609.07061, 2016, [Online]. Available: http://arxiv.org/abs/1609.07061
[22] Uday Kulkarni, Meena S. M., Sunil V. Gurlahosur, Gopal Bhogar, Quantization Friendly MobileNet (QF-MobileNet) Architecture for Vision Based Applications on Embedded Platforms, Neural Networks, Volume 136, 2021,Pages 28-39, ISSN 0893-6080, https://doi.org/10.1016/j.neunet.2020.12.022.
[23] R. Banner, Y. Nahshan, E. Hoffer, and D. Soudry, “ACIQ: Analytical Clipping for Integer Quantization of neural networks,” CoRR, vol. abs/1810.05723, 2018, [Online]. Available: http://arxiv.org/abs/1810.05723
[24] M. Nagel, M. Fournarakis, R. A. Amjad, Y. Bondarenko, M. van Baalen, and T. Blankevoort, “A White Paper on Neural Network Quantization,” CoRR, vol. abs/2106.08295, 2021, [Online]. Available: https://arxiv.org/abs/2106.08295
[25] Dave Salvator, Hao Wu, Milind Kulkarni and Niall Emmart, Int4 Precision for AI Inference, Nvidia Blog, November, 2019, https://developer.nvidia.com/blog/int4-for-ai-inference/
[26] M. Courbariaux and Y. Bengio, “BinaryNet: Training Deep Neural Networks with Weights and Activations Constrained to +1 or −1,” CoRR, vol. abs/1602.02830, 2016, [Online]. Available: http://arxiv.org/abs/1602.02830
[27] M. Rastegari, V. Ordonez, J. Redmon, and A. Farhadi, “XNOR-Net: ImageNet Classification Using Binary Convolutional Neural Networks,” CoRR, vol. abs/1603.05279, 2016, [Online]. Available: http://arxiv.org/abs/1603.05279
[28] Chen et al., “TVM: End-to-End Optimization Stack for Deep Learning,” CoRR, vol. abs/1802.04799, 2018, [Online]. Available: http://arxiv.org/abs/1802.04799
[29] Nvidia TensorRT Introduction. Available online: https://developer.nvidia.com/tensorrt (accessed on 21 May 2022).
[30] S. Hochreiter and J. Schmidhuber, “Long Short-Term Memory,” Neural Comput., vol. 9, no. 8, pp. 1735-1780, November 1997, doi: 10.1162/neco.1997.9.8.1735.
[31] K. Simonyan and A. Zisserman, “Very deep convolutional networks for large-scale image recognition,” arXiv preprint arXiv:1409.1556, 2014.
[32] S. Choi, K. Shim, J. Choi, W. Sung, and B. Shim, “TernGEMM: GEneral Matrix Multiply Library with Ternary Weights for Fast DNN Inference,” in SiPS, 2021, pp. 111-116. [Online]. Available: https://doi.org/10.1109/SiPS52927.2021.00028
[33] J. Won, J. Si, S. Son, T. J. Ham, Kai J. W. Lee, ‘ULPPACK: Fast Sub-8-bit Matrix Multiply on Commodity SIMD Hardware’, σTO Proceedings of Machine Learning and Systems, 2022, T. 4, 6a. 52-63.

1. A system for deploying neural networks in low bit environments, the system comprising:
a runtime platform;
a first set of configuration parameters identifying limitations of the runtime platform;
a quantization platform for quantizing neural networks, the quantization platform:
receiving a neural network associated with a framework and quantizing the neural network into a smaller neural network; and
generating a dataset comprising a second set of configuration parameters for compiling the smaller neural network into instructions for the runtime platform, the second set of configuration parameters being responsive to the limitations of the first set of configuration parameters; and
wherein the runtime environment implements the smaller neural network in accordance with the second set of configuration parameters.

2. The system of claim 1, wherein:
the runtime platform includes two or more operators; and
the second set of configuration parameters specify at least one of (1) an order of the two or more operators, or (2) a composition of the two or more operators for use by the runtime environment.

3. The system of claim 1, wherein the first set of configuration parameters relate to at least one of a target precision, a resulting layout of the smaller neural network, a target accuracy, and a target architecture.

4. The system of claim 3, wherein the target architecture indicates the two or more operators.

5. The system of claim 1, wherein at least some of the second set of configuration parameters are for a subset of the plurality of nodes.

6. The system of claim 1, wherein the first set of configuration parameters or the second set of configuration parameters comprises different configuration parameters for different nodes of the plurality of nodes.

7. The system of claim 1, wherein quantizing the network comprises training the neural network to satisfy at least one of the first set of configuration parameters.

8. The system of claim 7, wherein the training is performed with a first device, and the smaller neural network is output to a second device.

9. The system of claim 1, wherein the quantization platform reuses the first set of configuration parameters for quantizing another neural network.

10. A method for deploying neural networks in low bit environments, the method comprising:
providing a quantized neural network having a plurality of operations;
providing a set of configuration parameters for implementing the quantized neural network with a runtime platform having two or more operators;
compiling the quantized neural network to generate compiled code, the compiled code specifying implementing at least some of the plurality of operations of the generated compiled code with one of the two or more operators, based on the set of configuration parameters; and
implementing the generated compiled code with the runtime platform.

11. The method of claim 10, wherein the set of configuration parameters specifies implementing different operators of the two or more operators for different parts of the compiled code.

12. The method of claim 10, wherein the two or more operators include at least one custom operator.

13. The method of claim 10, wherein the set of configuration parameters specifies different operators of the two or more operators for different layers of the quantized neural network.

14. The method of claim 10, further comprising:
providing a neural network from a framework associated with a second runtime platform having one or more operators;
quantizing the neural network into the quantized neural network,
wherein the set of configuration parameters for implementing the quantized neural network specifies implementing at least some of the plurality of operations of the generated compiled code with the one or more operators of the first runtime environment and further specifies implementing at least some of the plurality of operations of the generated compiled code with the two or more operators.

15. The method of claim 10, further comprising updating the two or more operators.

16. The method of claim 10, wherein compiling the quantized neural network comprises casting elements of the quantized neural network from a first data type into a second data type.

17. The method of claim 10, wherein the runtime platform can process compiled code from different code compilers, or operate on more than one device type.

18. The method of claim 10, wherein the set of configuration parameters specify a target encoding scheme for at least some weights and activations of the quantized neural network.

19. The method of claim 18, wherein the target encoding scheme is unipolar or bipolar.

20. A computer readable medium storing computer executable instructions which cause a processor to:
provide a quantized neural network having a plurality of operations;
provide a set of configuration parameters for implementing the quantized neural network with a runtime environment having two or more operators;
compile the quantized neural network to generate compiled code, the compiled code specifying implementing at least some of the plurality of operations of the generated compiled code with one of the two or more operators, based on the set of configuration parameters; and
implement the generated compiled code with the runtime environment.
